(19) United States
(12) Patent Application Publication
(10) Pub. No.: US 2019/0193479 A1
(43) Pub. Date: Jun. 27, 2019

(54) SENSOR SYSTEM FOR MONITORING TIRE WEAR

(71) Applicant: The Goodyear Tire & Rubber Company, Akron, OH (US)

(72) Inventors: Carl Trevor Ross Pulford, Akron, OH (US); Cheng-Hsiung Lin, Hudson, OH (US)

(21) Appl. No.: 16/225,228

(22) Filed: Dec. 19, 2018

Related U.S. Application Data
(60) Provisional application No. 62/608,157, filed on Dec. 20, 2017.

(51) Int. Cl. B60C 11/24; H01Q 1/22

(52) U.S. Cl. CPC B60C 11/243; G06K 19/0723; H01Q 1/2241; B60C 11/246

(57) ABSTRACT

A tread wear indicator is affixed to a respective tire tread element. The indicator is constructed as a plurality of radially stacked sensor elements operatively configured and located to sequentially sacrificially abrade and change in electrical resistance responsive to a progressive tread wear of the respective tread element. The sensor elements are connected by circuitry that communicates a data signal from the sensor elements to a data processor indicative of a change in cumulative resistivity of the sensor elements. The data processor receives the data signal from the sensor elements and determines a radial wear level of the tread element based on the data signal. Multiple tread wear indicators may be mounted to respective tread lugs across the tread to derive a tread wear status based upon the tread wear profiles of the respective lugs.

### FIELD OF THE INVENTION

The invention relates generally to a sensing system for real-time monitoring of tire wear over its life time and, more specifically, to a sensing system based on tire-embedded tread wear sensor implementation.

### BACKGROUND OF THE INVENTION

The use of tread wear indicators is not new and the use of tread wear indicators is mandated by law in many countries. A variety of such indicators are known. Once such type employs colored indicia below the tread for a visual indicator of wear. Other types use tie-bar type elements in the tread grooves.

The practical problem with the colored indicators of the type mentioned is that there is no way for the operator to determine the level of wear until the tire is worn. When the tire employs the tie-bar type wear indicator, it can be difficult to determine the level of wear.

U.S. Pat. No. 6,523,586 discloses wear indicators for a tire tread wherein, in a series, or predetermined closely located grouping, of related marks, the marks disappear as the tire is worn. While this provides continuous information to the consumer, the complexity of forming the tire is increased due to the need to form multiple different marks that appear only after a defined amount of wear.

A cheap and effective tread wear indicator which is readily integrated into a tire and which reliably measures tread wear in a manner easily monitored by a vehicle operator is, accordingly, desired and heretofore unattained.

### SUMMARY OF THE INVENTION

According to an aspect of the invention, a vehicle tire and tread wear device assembly includes a tread wear indicator affixed to one or more tire tread elements.

### Definitions

“Groove” means an elongated void area in a tread that may extend circumferentially or laterally about the tread in a straight curved, or zigzag manner. Circumferentially and laterally extending grooves sometimes have common portions and may be sub classified as “wide”, “narrow”, or “sipe”. The slot typically is formed by steel blades inserted into a cast or machined mold or tread ring therefor. In the appended drawings, slots are illustrated by single lines because they are so narrow.

A “sipe” is a groove having a width in the range from about 0.2 percent to 0.8 percent of the compensated tread width, whereas a “narrow groove” has a width in the range from about 0.8 percent to 3 percent of the compensated tread width and a “wide groove” has a width greater than 3 percent thereof. The “groove width” is equal to tread surface area occupied by a groove or groove portion, the width of which is in question, divided by the length of such groove or groove portion; thus, the groove width is its average width over its length. Grooves, as well as other voids, reduce the stiffness of tread regions in which they are located. Sipes often are used for this purpose, as are laterally extending narrow or wide grooves. Grooves may be of varying depths in a tire. The depth of a groove may vary around the circumference of the tread, or the depth of one groove may be constant but vary from the depth of another groove in the tire. If such narrow or wide groove are of substantially reduced depth as compared to wide circumferential grooves which they interconnect, they are regarded as forming “tie bars” tending to maintain a rib-like character in the tread region involved.

“Inner” means toward the inside of the tire and “outer” means toward its exterior.

“Outer” means toward the tire's exterior.

“Radial” and “radially” are used to mean directions radially toward or away from the axis of rotation of the tire.

“Tread” means a molded rubber component which, when bonded to a tire casing, includes that portion of the tire that comes into contact with the road when the tire is normally inflated and under normal load. The tread has a depth conventionally measured from the tread surface to the bottom of the deepest groove of the tire.

“Tread Element” is a protruding portion of a tread such as a lug or rib which constitutes the element that comes into contact with the road.

### BRIEF DESCRIPTION OF THE DRAWINGS

The invention will be described by way of example and with reference to the accompanying drawings in which:

FIG. 1 is a perspective view of a tire and tread wear sensor assembly;

FIG. 2 is a close-up front view of a tire and tread wear sensor assembly;

FIG. 3 is a perspective cross-sectional view of a tire tread showing the sensor location;

FIG. 4 is a top view of FIG. 3 illustrating the tire grooves, sensor pocket and sipe;

FIG. 5 is a plan view of the sensor and sensor mount;

FIG. 6 is a side view of the sensor and sensor mount;

FIG. 7A is a schematic of a circuit suitable for use as a tread wear sensor;

FIG. 7B is a photograph of the circuit of FIG. 7A printed on rubber;

FIG. 8 is a schematic of a second embodiment of a circuit suitable for use as a tread wear sensor;

FIG. 9 is a schematic of a third embodiment of a circuit suitable for use as a tread wear sensor;

FIG. 10 is a schematic of a fourth embodiment of a circuit suitable for use as a tread wear sensor;

FIG. 11 is a schematic of a RFID system with sensor capability;

FIG. 12 is a schematic of a RFID tag wherein the system communicates with a plurality of sensors;

FIG. 13A is a block diagram of a chipless RFID tag;

FIG. 13B is a photograph of an exemplary printed chipless RFID tag;

FIG. 14 is a schematic diagram of a vehicle having a tire and tread wear assembly mounted on each axle, and a hub mounted miniature RFID reader with a power receiver, and a central wireless charging transmitter mounted on the vehicle;

FIG. 15 is a schematic diagram of a vehicle having a tire and tread wear assembly mounted on each axle, and a vehicle mounted miniature RFID reader with power source from the vehicle;

FIG. 16 is a schematic diagram of a vehicle having a tire and tread wear assembly mounted on each axle, and a single vehicle mounted RFID reader with power source from the vehicle;

### DETAILED DESCRIPTION OF THE INVENTION

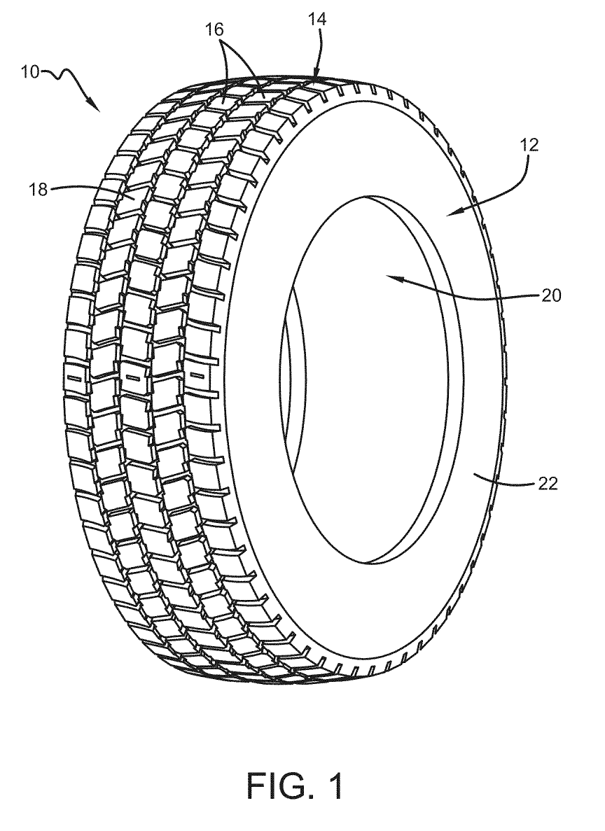

Referring to FIG. 1, an example tire 10 is shown having a sidewall 12 and a radially outward tread 14. The tread 14 as shown may further include one or more tread elements 18, such as for example, multiple rows of tread lugs 16. However, the tread elements 18 may also be tread blocks or tread ribs. However, the invention is not limited to a tread with tread elements 18, and may also be used on a smooth outer tread surface having no tread elements. The tire 10 further includes an inner liner or air impervious layer 20. Pursuant to conventional tire construction, the tire 10 is formed as a tire carcass 22 in a green tire build procedure and subsequently cured into the finished tire product.

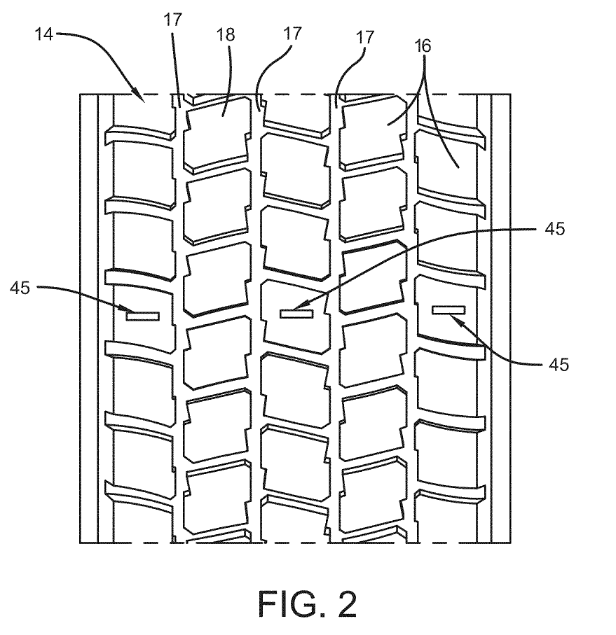

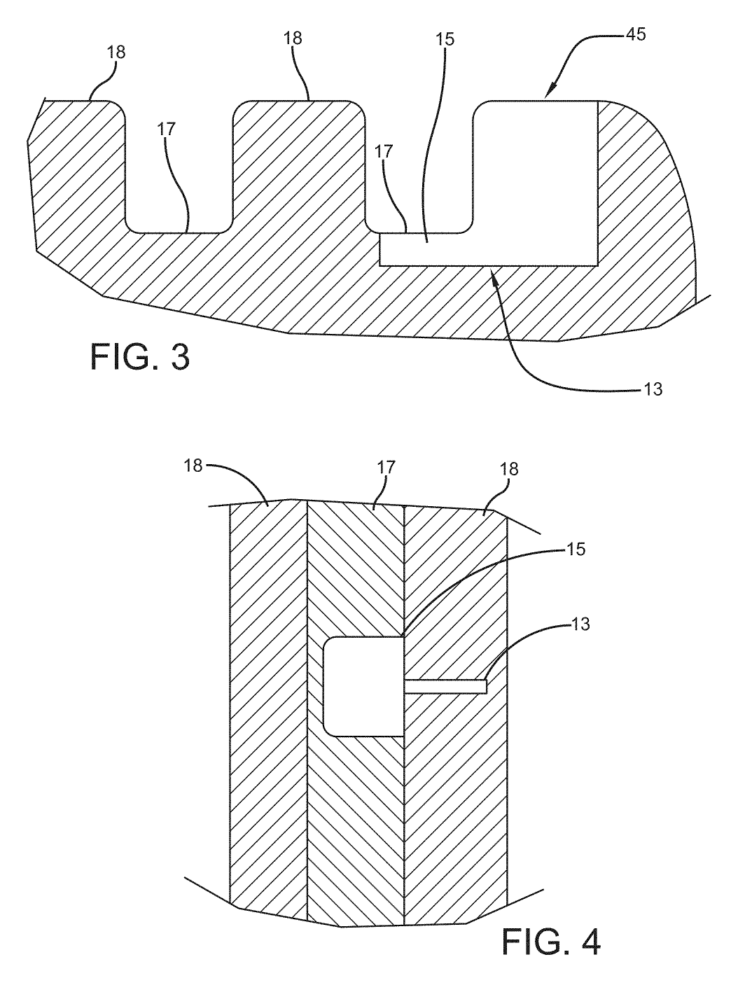

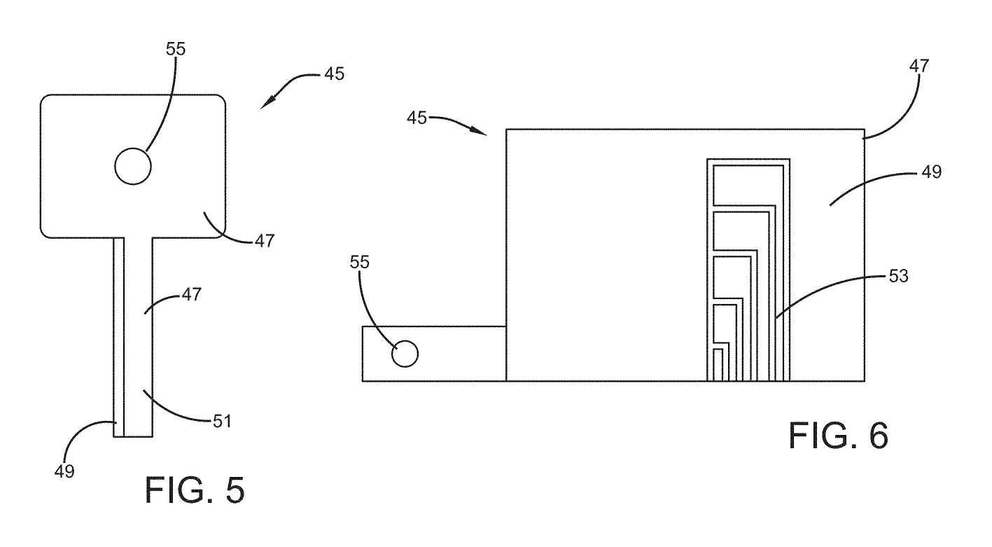

FIG. 2 illustrates an enlarged view of the tread region, illustrating the tread rows 16 formed by the spaced apart tread elements 18 that are separated by circumferential grooves 17. At least one of the tread elements 18, and preferably multiple tread elements, are equipped with a sensor 45, also referred herein as a “wear sensor” or “treadwear indicator.” The purpose of the sensor is to detect the progressive wearing of the tread elements 18 or the depth of a tire tread having no tread elements. One or more of the tread wear sensors 45 are mounted in the tread attached in order to monitor the general tread wear of the tire. By monitoring tread wear, the wear status of the tire may be ascertained. From determining the wear status of the tire, a decision on whether and when to replace the worn tire may be made.

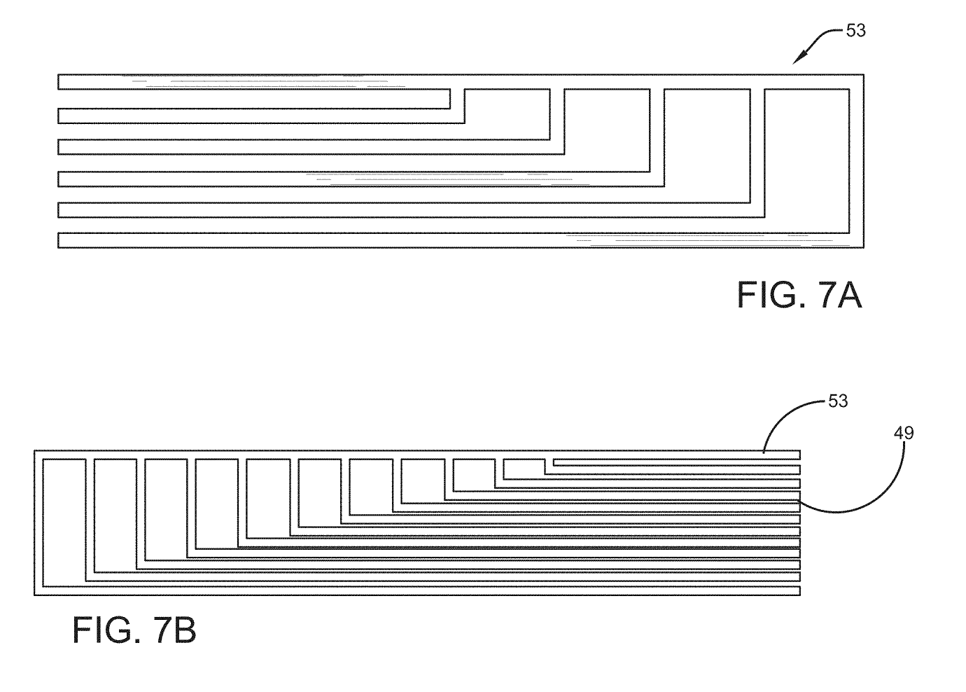

With reference to FIG. 6, the principle by which the tread wear sensors 45 operate will be understood. Each tread wear sensor 45 includes an L shaped insert 47 that is made out of a thin layer 49 of rubber or elastomer or a thin layer 49 of rubber applied to an optional thin metal blade 51. The thin layer of rubber has a printed circuit 53 on its outer surface. An RFID tag in chip form 55 is mounted on the lower end of the L shaped insert and is in electrical communication with the printed circuit 53. The printed circuit 53 is also shown in FIG. 7A, and printed on rubber with stretchable ink in FIG. 7B. The printed circuit 53 is a type of on/off circuit that has multiple layers that are positioned in a radial direction of a tread, so that as the tread wears, the layers are sacrificed, indicating the level of wear by determining the tread depth associated with the remaining circuits that are not shorted. The rubber may be cured or uncured. rubber. Preferably, the rubber is cured. The ink must be stretchable, and be electrically conductive. One suitable ink for use in a tire is made by EMS, Inc in Delaware, Ohio and is sold under the commercial code CI-2061. In one example, the type of ink that would work is graphite ink.

The assembled tread wear sensor 45 is mounted post cure in a cured tire. A sipe 13 or narrow groove is molded in the green tire or cut into the cured tire 12. A pocket 15 is formed in the bottom of a groove 17, under the Non-skid depth. The tread wear sensor 45 is inserted into the pocket and sipe and glued into place. The RFID tag is located in the pocket, while the printed circuit 53 is received in the sipe 13. The RFID tag is preferably a passive tag, and more preferably a UHF passive tag.

FIG. 8 illustrates a second embodiment of a circuit 100 that may be used as a tread wear sensor and printed on the rubber layer 49. The circuit is a circuit with a plurality of capacitors 102 arranged in series having different radial lengths which may be oriented in the radial direction of the tread. After the circuit is printed, a small amount of electroactive polymer or piezoelectric material is inserted to act as the capacitors. The printed circuit 100 in conjunction with the capacitors is a type of on/off circuit that has multiple layers that are positioned in a radial direction of a tread, so that as the tread wears, the layers in series are sacrificed, indicating the level of wear by determining the tread depth associated with the change in capacitance or electrical signal.

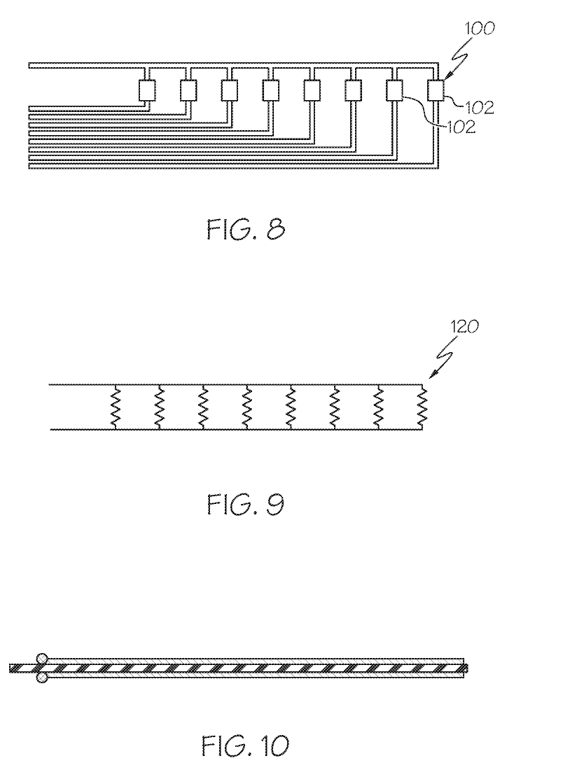

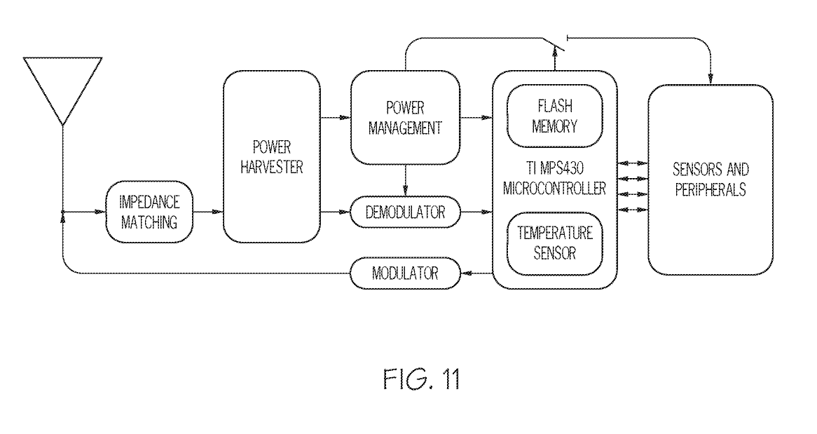

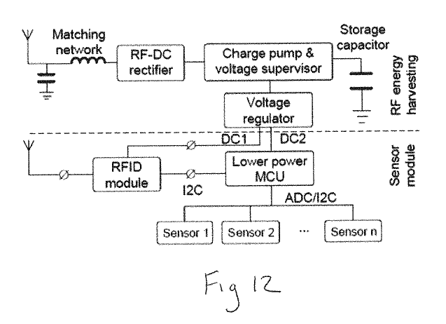

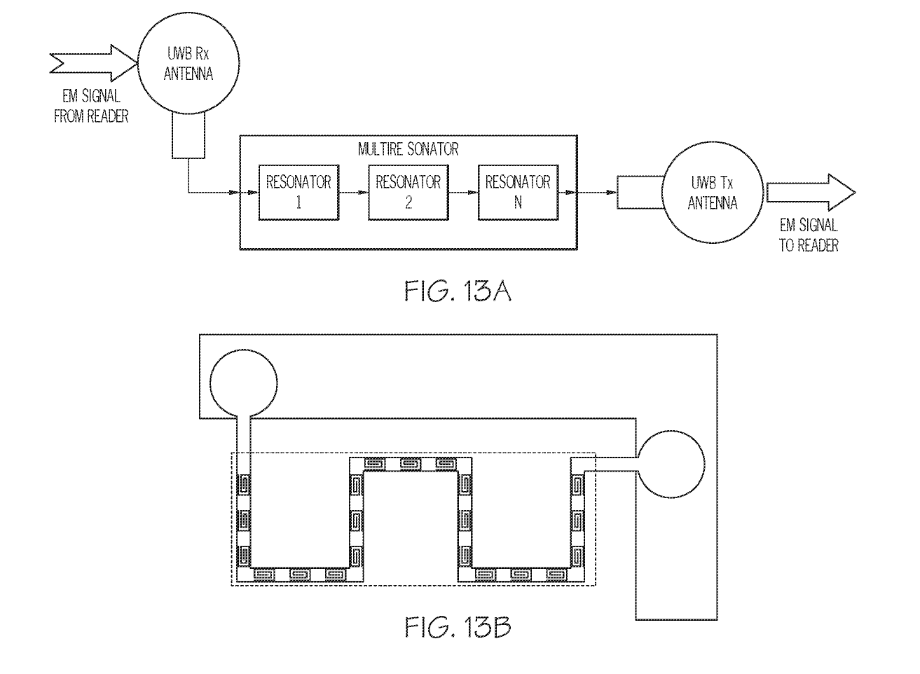

FIG. 9 illustrates a third embodiment 120 of a printed circuit suitable for use as a tread wear sensor for printing on the rubber layer 49. The circuit 120 includes a plurality of resistor elements 122 arranged in parallel, and are positioned in a radial direction of a tread, so that as the tread wears, the layers in parallel are sacrificed, indicating the level of wear by determining the tread depth associated with the change in resistance. Thus, the amount of tread wear can be determined by the change of resistance from the circuit.

FIG. 10 illustrates a fourth embodiment 130 of a printed circuit suitable for use as a tread wear sensor for printing on the rubber layer 49. The circuit 130 includes a rubber layer having a first conductive plate A on a first side, and a second conductive plate B on a second side separated by the rubber layer. The first and second conductive plates act as a capacitor. The change in capacitance signal indicates the remaining tread depth. The capacitors may be printed or painted on each side of a rubber swatch using conductive stretchable ink. More preferably, the above described circuits are used in conjunction with a printed RFID tag, i.e., a chipless RFID tag. One example of a chipless RFID tag is shown in FIG. 13A. The chipless RFID tag includes a first antenna such as a UWB Rx antenna, a second antenna such as a UWB Tx antenna, and a multiresonator formed of a plurality of resonators. FIG. 13B illustrates a printed RFID tag that has no chip. The chipless RFID tag is in electrical communication with a printed circuit.

### Reader Location and Power Options

Each reader 40 may be a small volt meter or electronic receiver, electronic transceiver or preferably a passive RFID (RadioFrequency IDentification) sensor that also includes functionality to sample and measure parameters such as voltage.

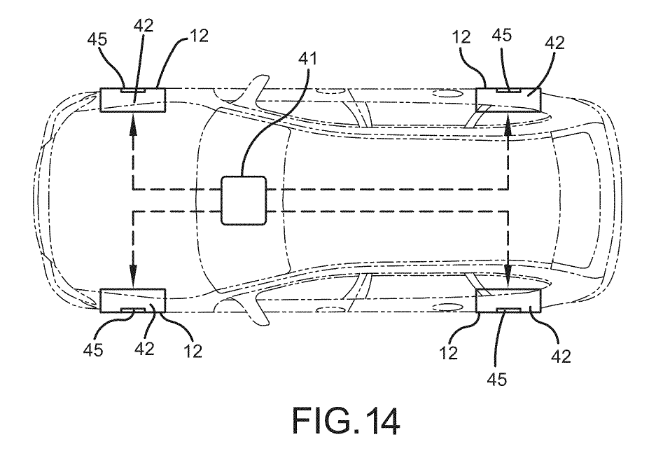

In another embodiment as shown in FIG. 14, there are four miniature readers 40 located at each vehicle axle, wherein the readers 40 are mounted on a tire component such as the innerliner or bead, or outside the tire such as on the wheel, or the vehicle axle. Each miniature reader 40 is preferably passive and in electrical communication with a power receiver 42 so that it would be powered wirelessly by electromagnetic waves from a central vehicle wireless charging transmitter 41. The wireless charging transmitter 41 is powered by the vehicle battery and wirelessly charges each miniature reader 40 via the power receiver 42.

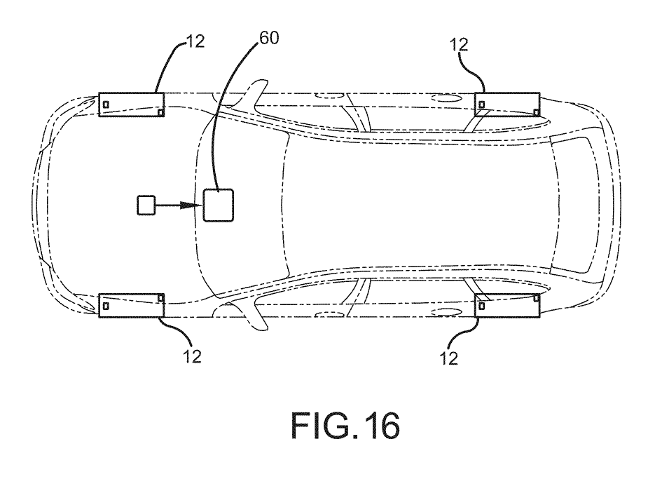

An alternative embodiment is shown in FIG. 16 wherein there is a single RFID reader 60 that is mounted in the vehicle and is powerful enough to read the signals from the sensors. the reader 60 receives power from the vehicle battery.

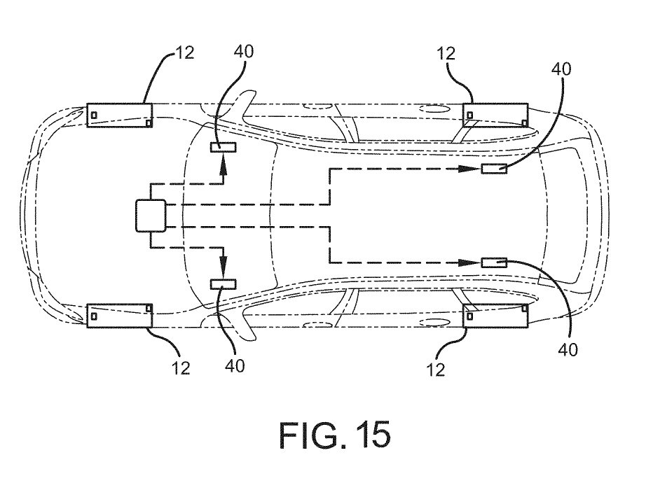

In an alternate embodiment, the reader is at a remote location such as a drive over reader device. Alternatively, the reader may be powered by a small battery or energy harvestor embedded in the patch, or be hardwired to the vehicle battery as shown in FIG. 15.

The tread depth measurement would only need to be taken at low frequency and transmitted infrequently e.g., once a month due to the slow wear rate of tires, so power requirements would be low. The tread depth readings could be stored on a server for commercial tire management & data analysis. For consumer tires, the server could send emails to consumer warning of need to replace a worn-out tire. In addition, the non-skid of all four tires on a passenger car could be monitored as well as say both shoulders of each to give info on alignment maintenance. This convenience would be even more valuable on commercial fleet vehicles where the non-skid of all 18 wheels could be monitored automatically.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A vehicle tire and tread wear sensor comprising:
a tire having a tread;
a tread wear sensor mounted in the tread, said tread wear sensor comprising a thin layer having an outer surface having a printed circuit using conductive ink, wherein the tread wear sensor is positioned in a groove or sipe of the tread, wherein the printed circuit is in electrical communication with a RFID tag.

2. The vehicle tire and tread wear sensor of claim 1 wherein the thin layer is rubber.

3. The vehicle tire and tread wear sensor of claim 1 wherein the printed circuit includes one or more resistors arranged in parallel, wherein the resistors are oriented in the radial direction of the tread.

4. The vehicle tire and tread wear sensor of claim 1 wherein the printed circuit includes one or more capacitors arranged in parallel wherein the capacitors are oriented in the radial direction of the tread.

5. The vehicle tire and tread wear sensor of claim 4 wherein the capacitor is an electroactive polymer.

6. The vehicle tire and tread wear sensor of claim 1 wherein the thin layer has a capacitor printed or painted on a first side and a capacitor printed or painted on a second side.

7. The vehicle tire and tread wear sensor of claim 1 wherein the circuit is printed using a stretchable ink.

8. The vehicle tire and tread wear sensor of claim 1 wherein the printed circuit is in electrical communication with at least one electrical element, wherein the electrical element is made of an electroactive polymer for emitting a voltage in response to deformation of the tread.

9. The vehicle tire and tread wear sensor of claim 1 wherein the RFID tag is printed on the thin layer of rubber, and is in electrical communication with the printed circuit.

10. The vehicle tire and tread wear sensor of claim 1 wherein the RFID tag is a chip mounted on the insert.

11. The vehicle tire and tread wear sensor of claim 1 wherein the RFID tag is a chip mounted on the tread in a groove.

12. The vehicle tire and tread wear sensor of claim 3 wherein the RFID tag is a chip mounted on the tread in a pocket of a groove.

13. The vehicle tire and tread wear sensor of claim 1 wherein the tread wear sensor is mounted in the tread in a sipe post cure of the tire.

14. The vehicle tire and tread wear sensor of claim 1 further comprising a reader.

15. The vehicle tire and tread wear sensor of claim 1 further comprising data processing means for determining a tread wear status of the tread based on the absence of an electrical signal from the electrical element.

16. The vehicle tire and tread wear sensor of claim 1 wherein the RFID tag is passive.

17. A vehicle tire and tread wear sensor comprising:
a tire having a tread; a tread wear sensor mounted in the tread, said tread wear sensor comprising a thin layer having an outer surface having a printed circuit using conductive ink, wherein the tread wear sensor is mounted to the side of a tread element, wherein the printed circuit is in electrical communication with a RFID tag.
